(19) United States
(12) Patent Application Publication
(10) Pub. No.: US 2004/0086141 A1
(43) Pub. Date: May 6, 2004

(54) Wearable buddy audio system

(76) Inventor: Arthur E. Robinson, Denver, CO (US)

Correspondence Address: LATHROP & GAGE LC, 4845 PEARL EAST CIRCLE, SUITE 300, BOULDER, CO, 80301, US

(21) Appl. No.: 10/648,576

(22) Filed: Aug. 26, 2003

Related U.S. Application Data
(60) Provisional application No. 60/406,018, filed on Aug. 26, 2002.

(51) Int. Cl. H04R 5/02

(52) U.S. Cl. 381/301

(57) ABSTRACT

A portable audio system allowing simultaneous listening and/or audio communication by multiple individuals to a personal electronic device such as a CD player, tape player, radio, or cellular or wireless telephone. The audio system includes a personal electronic device, a transmitter in wireless communication with a plurality of wearable audio speakers and a power supply. Alternately, a hardwired connection between the transmitter and the plurality of speakers may be employed.

### FIELD OF INVENTION

The present invention is generally directed to an audio system to be used simultaneously by more than one person, which system is connected to or in communication with a conventional source of audio signals, such as a radio, a tape player, CD player, a cellular telephone, etc.

### BACKGROUND OF INVENTION

There are a multitude of situations where it becomes desirable to provide audio output to more than one individual simultaneously from a portable entertainment and/or personal communication system. For example, where two friends are jogging together and want to listen to the same CD in a CD player, or for example, where two or more individuals in one location want to participate in a cellular telephone conversation with another person at a separate location.

There is substantial prior art regarding wearable speaker or audio systems for use with conventional portable entertainment and personal communication systems. However, the prior art does not teach the use of the wearable speaker or audio system by more than one person at a time.

### BRIEF DESCRIPTION OF DRAWINGS

The invention will be clearly understood by those skilled in the art by reference to the accompanying drawings, wherein the invention is depicted in an illustrative manner:

FIG. 1 is a depiction of the components of the wearable buddy audio system for a portable personal electronic entertainment device, such as a CD player, tape player, or radio.

FIG. 2 is a depiction of the components of the wearable buddy audio system for a portable electronic communication device, such as a cellular or wireless telephone.

### DETAILED DESCRIPTION OF THE PREFERRED EMBODIMENT

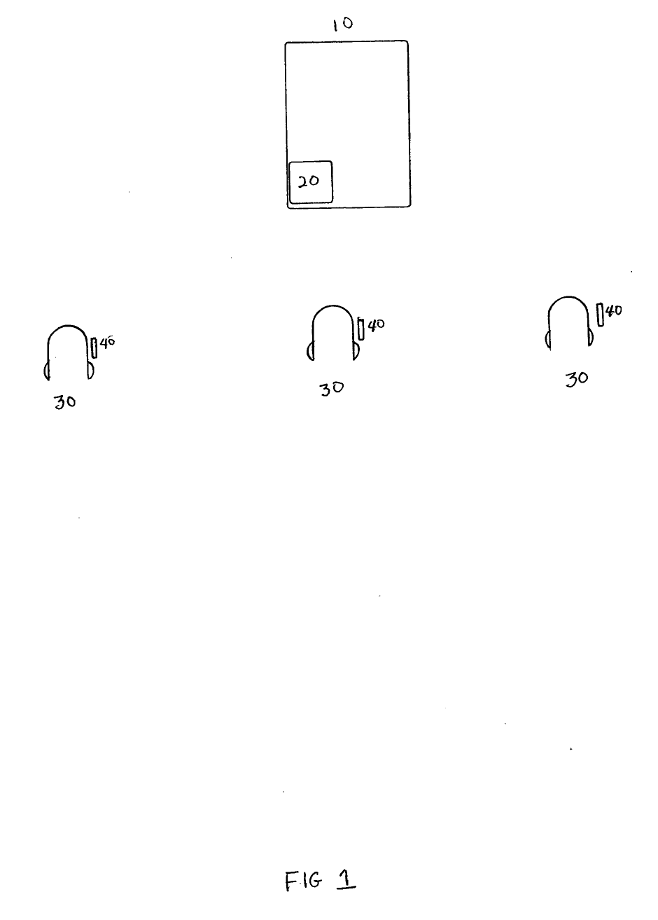

The wearable buddy audio system includes a single traditional personal electronic entertainment device such as a CD player, tape player, radio, cellular or wireless telephone 10 (FIG. 1), a transmitter 20 attached to or included in the electronic entertainment device for transmitting audio simultaneously to a plurality of wearable audio speakers 30, such as headphones, and a power supply 40 being worn by more than one individual at the same time. The preferred embodiment of this system is for wireless communication between the transmitter 20 and the plurality of speakers 30 because it provides the individuals with more freedom of movement. A hardwired connection between the transmitter 20 and the audio speakers 30 may also be used.

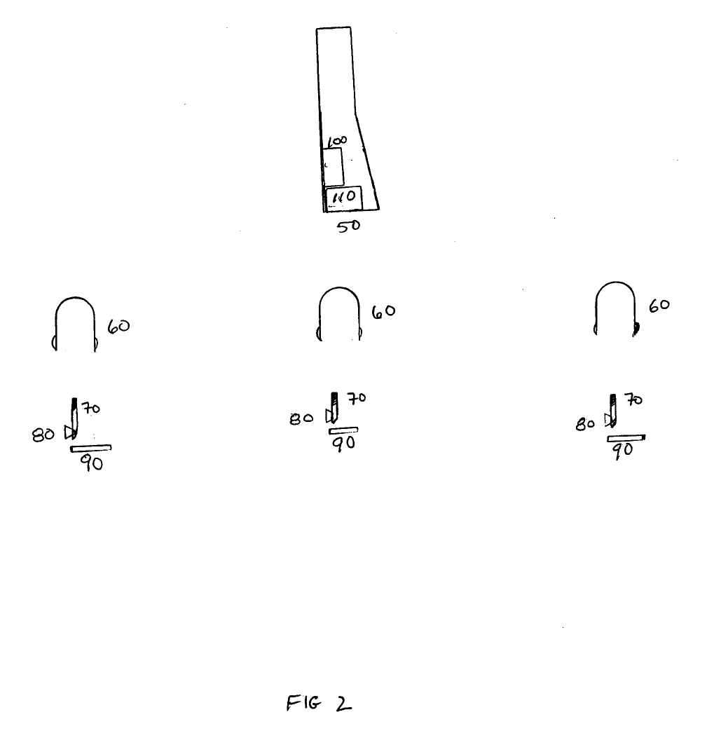

An alternative embodiment of this invention is for use with a personal electronic audio communication device, such as a cellular or wireless telephone, which is shown in FIG. 2. In this embodiment, the system comprises a single personal electronic audio communication device 50, a plurality of wearable audio speakers 60, microphones 70, transmitters 80, and power supply 90 being worn by more than one individual, and a separate transmitter 100 and receiver 110 attached to the personal communication device 50 for transmitting audio communications simultaneously to audio speakers 60 and receiving audio sound from the personal transmitters 80. Again, in this preferred embodiment, the preference is to use wireless communications between the electronic audio communication device 50 and the wearable audio speakers 60 and transmitters 80 because it gives the individuals more freedom movement. A hardwired connection may also be used.

I claim:

1. A portable audio system comprising:
a single personal, portable electronic audio entertainment device;
a plurality of wearable speakers being worn by a plurality of individuals; a power supply connected to aid speakers and being worn by each said individual;
a means for simultaneously transmitting audio from said entertainment device to said wearable speakers; and
a means for receiving the transmitted audio attached to said wearable speakers.

2. A portable audio system as recited in claim 1, where the transmission of audio from said entertainment device to said wearable speakers is by wireless transmission.

3. A portable audio system comprising:
a single personal, portable electronic audio communication device;
a plurality of wearable speakers being worn by a plurality of individuals;
a microphone and transmitter being worn by each said individual;
a power supply connected to said speakers, microphone, and transmitter and also being worn by each said individual;
a means for simultaneously transmitting audio from said communication device to said wearable speakers;
a means for receiving the transmitted audio attached to said wearable speakers.
a means for transmitting audio from said individuals to said communication device; and
a means for receiving audio from said individuals by said communication device.

4. A portable audio system as recited in claim 3, where the transmission of audio from said communication device to said wearable speakers and from said individuals to said communication device is by wireless transmission.
